(19) United States
(12) Patent Application Publication
(10) Pub. No.: US 2021/0004453 A1
(43) Pub. Date: Jan. 7, 2021

(54) DEVICE-SPECIFIC AUTHENTICATION CREDENTIALS

(71) Applicant: iboss, Inc., Boston, MA (US)

(72) Inventor: Paul Michael Martini, Boston, MA (US)

(21) Appl. No.: 16/919,998

(22) Filed: Jul. 2, 2020

Related U.S. Application Data
(63) Continuation of application No. 13/857,714, filed on Apr. 5, 2013, now abandoned.

(51) Int. Cl. G06F 21/44

(52) U.S. Cl. CPC G06F 21/44

(57) ABSTRACT

Methods and systems for providing device-specific authentication are described. One example method includes generating device-specific credentials, associating the device-specific credentials with a device, authenticating the device based on the device-specific credentials, and after authenticating the device, authenticating a user of the device based on user-specific credentials associated with the user and different than the device-specific credentials.

### CROSS-REFERENCE TO RELATED APPLICATIONS

This application is a continuation application of and claims priority to U.S. application Ser. No. 13/857,714, filed on Apr. 5, 2013.

### BACKGROUND

This specification generally relates to providing device-specific authentication, and secure user authentication.

In corporate and other networks, users may be required to authenticate to a proxy server prior to accessing the Internet. One widely used authentication scheme is HyperText Transfer Protocol (HTTP) Basic Authentication (Basic Auth). In Basic Auth, a client sends its username and password in unencrypted plaintext to a server, such as, for example, a proxy server. The server authenticates the client and subsequently allows the client access to other resources, such as the Internet. In such a configuration, an attacker can monitor network packets to obtain the username and password of the client, and possibly compromise the security of the network.

### SUMMARY

In general, one aspect of the subject matter described in this specification may be embodied in systems, and methods performed by data processing apparatuses that include the actions of generating device-specific credentials, associating the device-specific credentials with a device, authenticating the device based on the device-specific credentials, and after authenticating the device, authenticating a user of the device based on user-specific credentials associated with the user and different than the device-specific credentials.

Another general aspect of the subject matter described in this specification may be embodied in systems, and methods performed by data processing apparatuses that include the actions of authenticating a first device based on a first set of device-specific credentials, after authenticating the first device, authenticating a user based on user-specific credentials associated with the user and different than the first set of device-specific credentials, wherein the authentication occurs while the user is using the first device, applying a first policy associated with the first device to the user while the user is using the first device, authenticating a second device based on a second set of device-specific credentials, after authenticating the second device, authenticating the user based on the user-specific credentials, the user-specific credentials being different than the second set of device-specific credentials, wherein the authentication occurs while the user is using the second device, and applying a second policy associated with the second device to the user while the user is using the second device, the second policy being different than the first policy.

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a diagram of an example environment.

FIG. 2 is a swim lane diagram of an example interaction between the components of the example network to perform two-stage device and user authentication.

FIG. 3 is a flow chart of an example process of generating and authenticating device-specific credentials.

FIG. 4A is a flow chart of an example process of tracking usage of a device and logging out a user if a maximum is reached.

FIG. 4B is a flow chart of an example process of applying different policies to a user on different devices.

FIG. 5 is a diagram of computing devices that may be used to implement the systems and methods described in this document.

Like reference numbers and designations in the various drawings indicate like elements.

### DETAILED DESCRIPTION

A proxy server often is used by a network owner or administrator to control access to an external network, such as the Internet, by users of an internal network, such as a Local Area Network (LAN). A proxy server may also save Internet bandwidth and provide security by filtering users' access to objectionable or dangerous Internet sites. In some implementations, a proxy server may perform user-identity-based authentication, without regard to the particular device that the user is using to communicate with the proxy server. In such configurations, determining the identity of the device from which the user is accessing the proxy may be difficult as the device's identity information may not be present in the request presented to the proxy. User credentials on internal networks typically are passed in unsecured, plaintext to the proxy server when authenticating the user, thus allowing an attacker to illicitly obtain user credentials of legitimate users simply by monitoring network traffic. Consequently, when a proxy server employs user-identity-based authentication, the attacker can use the illicitly obtained user credentials to access the proxy server using his or her own device.

With the recent proliferation of mobile devices, many network owners have adopted a Bring Your Own Device (BYOD) approach in which users can access internal networks using personal devices. In BYOD networks, shared devices provided by the network owner, and connected to the network, may also be used (e.g., communal PCs in a public library). In that case, identifying which device is accessing the proxy server may be preferable so that different Internet policies can be applied to it on a device-identity basis. A device identified during authentication as a shared device may require a policy that reflects the fact that the device is shared by multiple users, whereas another device that was identified during authentication as being associated only with a single, specific user may have a different policy reflecting that fact. For example, a policy for a shared device may require that a user be logged out after a certain amount of time to allow other users access to the shared device, while a single-user may not require such a policy. Accordingly, the present disclosure describes systems and methods for separately authenticating a device and a user of the device.

In some implementations, a policy may be created by an administrator to configure the proxy settings for a set of devices that will be accessing a proxy server. Based on the policy, the proxy server creates unique credentials for each unique device. The unique credentials, which can be generated randomly or by other suitable mechanisms, enable the associated device to be uniquely identified, for example, by its serial number or MAC address. Along with its unique credentials, each device may receive proxy information including the proxy server IP address and port. Each time the device accesses the proxy server, the device transmits its assigned device-specific credentials to the proxy server. The proxy server then maps the credentials back to the unique device. Once the device's identity is determined, the authentication policy assigned to the device is checked. If the device's authentication policy requires a user login, the proxy server may redirect the device to a secure web page at which the user may be authenticated using the assigned credentials. The web page verifies the user's credentials (e.g., such as by communicating with an authentication system). Each proxy request (e.g., web page requests) from that point forward is made with the device-specific credentials. The proxy server can reverse map each such request to the authenticated user credentials.

This approach has several potential advantages. First, it provides increased security by acquiring the user's credentials via a secure web page. Since only the device-specific credentials are sent as unencrypted plaintext, an attacker cannot acquire the user's credential by simply monitoring network traffic. And because the device-specific credentials may only allow the user of the device to access a secure authentication website, an attacker who learns only the device-specific credentials may only be able to access this website and not more sensitive resources such as an authentication server storing user account information.

Further, after the initial authentication, the device identity is known to the proxy server, thereby allowing the proxy server to perform device-specific actions such as logging the user out of a specific device after a certain amount of time. For example, assume that a user A is logged into a BYOD network using his personal mobile device but then decides also to login to the BYOD network using a shared device without logging his mobile device out of the network (i.e., both devices are authenticated on the network concurrently with the same user credentials). Because the systems and techniques described here enable the proxy server to uniquely identify, and apply different policies to, the different devices with which they are communicating, the proxy server can apply policies to user A's mobile device that differ from the policies applied to the shared device that user A is using, even though both devices are logged into the network using the same user credentials. For example, a time-out policy could be applied to the shared device, in which user A is logged out of the shared device after a predetermined period of time, while user A's mobile device could be allowed to remain logged into the BYOD network indefinitely. The device-specific credentials also provide an improved mechanism of identifying the device, as other identification mechanisms, such as IP addresses, may be inaccurate as they can be associated with different devices at different points in time. The auditing and separate policy advantages described above may be realized in both networks utilizing insecure authentication mechanisms (e.g., Basic Auth) and in networks utilizing other, more secure authentication mechanisms.

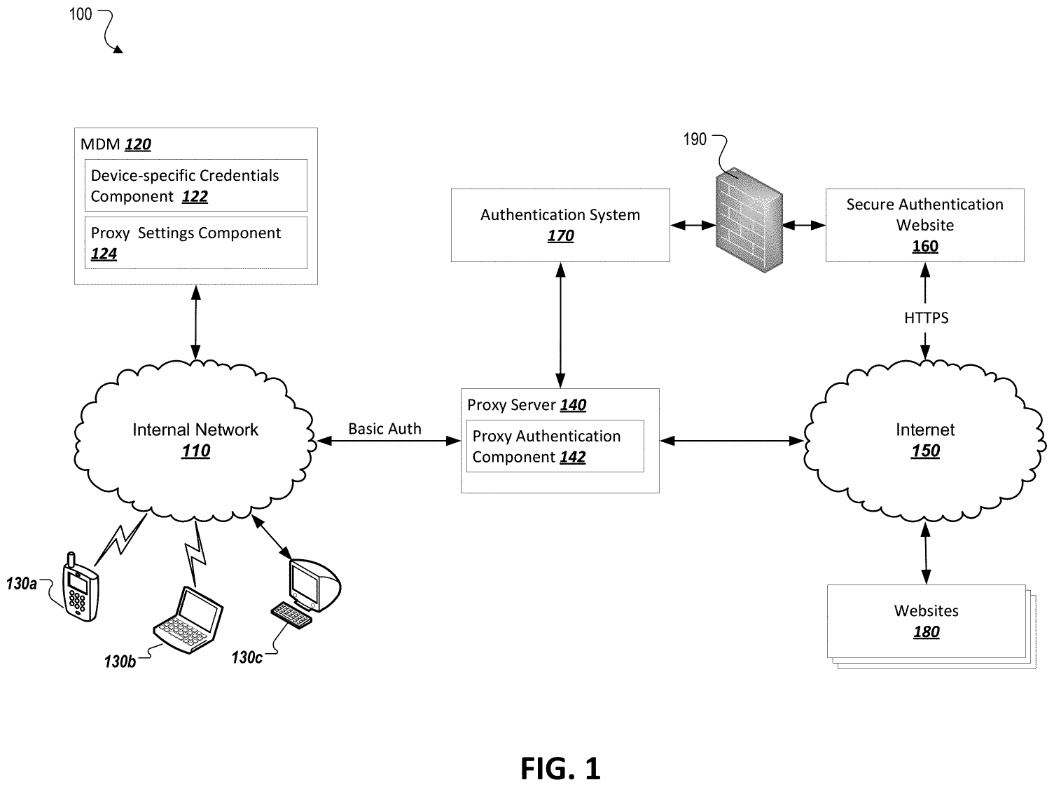

FIG. 1 is a diagram of an example environment 100 in which various aspects of the subject matter described here may be implemented. The environment includes an internal network 110 separated from the Internet 150 by a proxy server 140. One or more devices 130a-c are connected to the internal network 110. The mobile device manager (MDM) 120 is connected to the internal network 110 to manage device settings and configuration for the one or more devices 130a-c. In operation, the MDM 120 may provide proxy settings to the one or more devices 130a-c. The provided proxy settings may include device-specific credentials associated with each device 130a-c. The devices 130a-c, in turn, may use the device-specific credentials to authenticate to the proxy server 140, for example, using the Basic Auth mechanism.

The proxy server 140 may verify the device-specific credentials with an authentication system 170. After successful authentication of the device-specific credentials, each device 130a-c may be assigned a limited access profile by the proxy server 140. In some implementations, the limited access profile may include an indication of whether user authentication is required. The limited access profile may permit each device 130a-c to access only the secure authentication website 160 via the Internet 150. The user of each device must then provide user-specific credentials to the secure authentication website 160. In some implementations, this interaction may occur over a secure mechanism, such as, for example, Secure Socket Layer (SSL) via HTTP Secure (HTTPS). The secure authentication website 160 authenticates the user-specific credentials with the authentication system 170. In some implementations, this interaction may occur through firewall 190 or through other security measures. Once the user's user-specific credentials are authenticated, the proxy server 140 updates the associated device profile to allow the device to access one or more websites 180 in addition to the secure authentication website 160. In some implementations, the subsequent requests from the device are correlated with the user by examining the user-specific credentials associated with the device, and a user-specific profile is applied to the request.

As shown, the environment 100 includes an internal network 110. In some implementations, the internal network 110 may be a wireless network provided by a corporation, educational institution, municipality, business, or other entity. Such a wireless network may utilize any standard wireless networking technology, including 802.11a, 802.11b, 802.11g, 802.11n, LTE, WiMax, CDMA or any other suitable wireless networking technology. In such implementations, the wireless network may be a public network in the sense that any device within range may connect to the network. Even though any device within range may connect to the internal network 110 in such configurations, the device still may be required to authenticate in order to access resources on the internal network 110 and/or on the Internet 150. Such a configuration is often referred to as a Bring Your Own Device (BYOD) network in which users are free to use their own personal devices for connecting to the network. In some implementations, the entity that controls the internal network 110 may issue devices to users for use on the internal network 110. The internal network 110 may also be a wired network, such as an Ethernet network.

The environment 100 also includes one or more devices 130a-c connected to internal network 110. In some implementations, the one or more devices 130a-c include mobile devices, such as cellular telephones (e.g., 130a), smartphones, tablets, laptops (e.g., 130b) and other similar computing devices. The one or more devices 130a-c may also include wired devices such as desktop computer 130c. In some implementations, the one or more devices 130a-c include personal devices associated with one or more users. The one or more devices 130a-c may also include devices issued or owned by the entity that provides the internal network 110, such as company-issued smartphones or laptops. In some implementations, the one or more devices 130a-c may include network access or web browsing software (e.g., a web browser) for accessing resources on the Internet 150.

In the illustrated implementation, the environment 100 also includes an MDM 120. In some implementations, the MDM 120 is configured to provide network settings to the one or more devices 130a-c. Network settings may include device-specific credentials, proxy settings, or any other suitable settings associated with the one or more devices 130a-c. In some implementations, the MDM 120 allows an administrator to configure profiles including the various settings described above, and assign the one or more devices 130a-c to these profiles. A device assigned to a profile may be assigned the settings associated with the profile. In this way, common settings may be applied to multiple devices at once without having to enter the common settings for each device individually.

In some implementations, the MDM 120 may be a server or set of servers located on the internal network 110 and accessible by the one or more devices 130 a-c. The MDM 120 may be operable to push network settings to the one or more devices 130a-c at various times such as, for example, according to a regular update schedule, when triggered by an administrator, when requested by a device, and/or any other appropriate time.

The MDM 120 also includes a device-specific credentials component 122. In some implementations, the MDM 120 may allow an administrator to configure a profile such that each device assigned the profile will receive device-specific credentials. In such a configuration, the device-specific credentials component 122 may associate device-specific credentials with each device on the internal network 110 based on the configured profile. For example, the device-specific credentials component 122 may associate a different set of device-specific credentials for each of the devices 130a-c. In some implementations, the device-specific credentials may be generated by device-specific credentials component 122 according to parameters configured in the associated profile. For example, the device-specific credentials component 122 may generate a random username and password for a device based on a configuration setting in a profile. The device-specific credentials component 122 may also associate a set of credentials with a device by selecting from a plurality of available credentials and assigning the selected credentials to the device.

In some implementations, the device-specific credentials include a username and password to be provided by the device to the proxy server 140 for authentication. The device-specific credentials may also include other types of credentials, including, but not limited to, certificates, tokens, encryption keys, and/or any other suitable type of credentials.

The MDM 120 also includes a proxy settings component 124. In some implementations, the proxy settings component 124 may store and send proxy configuration information to the one or more devices 130a-c. The one or more devices 130a-c may use the proxy settings to communicate, and authenticate, with the proxy server 140. In some implementations, the proxy settings may include, but are not limited to, an IP address and port of the proxy server 140, a list of authentication mechanisms accepted by the proxy server 140, and/or any other suitable proxy settings.

As shown, the environment 100 also includes a proxy server 140 connected to the internal network 110 and the Internet 150. In some implementations, the proxy server 140 search is a gateway to a wide-area network (WAN), such as the Internet 150, for the one or more devices 130a-c. Requests made by the devices may be first passed to the proxy server 140, which will then pass the request on to the Internet 150. In some implementations, the proxy server 140 may perform filtering on these requests, such as blocking access to resources on the Internet 150 that are known to include objectionable or otherwise prohibited content. Proxy server 140 may perform this filtering by analyzing requests sent by the one or more devices 130a-c, identifying requests for Uniform Resource Locators (URLs) of known prohibited sites, and returning a response to the sending device indicating that the request will not be fulfilled.

The proxy server 140 includes a proxy authentication component 142. In some implementations, the proxy authentication component 142 interacts with the authentication system 170 to determine whether each of the one or more devices 130a-c is permitted to access the Internet 150. In some implementations, the proxy authentication component 142 may communicate with the authentication system 170 via an Application Programming Interface (API), via one or more network protocols such as Lightweight Directory Access Protocol (LDAP), and/or by any other suitable means.

In some implementations, the proxy server 140 is configured to receive device-specific credentials from the one or more devices 130a-c via the Basic Auth authentication mechanism. In such a configuration, the device-specific credentials are sent from the devices 130a-c to the proxy server 140 as unencrypted plaintext. In addition, the device-specific credentials are sent each time the one or more devices 130a-c sends a request for resource on the Internet 150 through the proxy server 140. For example, a Basic Auth request may be formatted as follows:

HTTP GET https://<username>:<password>@www.example.com/path

where “<username>” and “<password>” are the credentials associated with the request. The proxy server 140 may also receive authentication credentials through a secure authentication mechanism such as, for example, Secure Socket Layer (SSL) or Transport Layer Security (TLS).

In the illustrated implementations, the proxy server 140 is connected to an authentication system 170. In some implementations, the authentication system 170 may include a domain controller controlling access on the internal network 110. In some cases, the domain controller may be a Microsoft® Active Directory system, an Apple® Open Directory system, an OpenLDAP system, a Novell® eDirectory system, and/or any other suitable domain controller or combination of domain controllers. In some cases, the authentication system 170 may interact with the MDM 120 in the process of provisioning device-specific credentials. For example, the MDM 120 may communicate with the authentication system 170 to create a new device-specific username and password associated with a specific device.

As shown, the proxy server 140 is connected to the Internet 150. In some implementations, the Internet 150 is the public Internet. The Internet 150 may also be any network or combination of networks accessed from the internal network 110 via the proxy server 140. In such an implementation, the Internet 150 may be public, private, or a combination of the two. In some implementations, the Internet 150 is a distributed network utilizing the Transmission Control Protocol (TCP) in combination with HTTP to transmit requests for pages to web servers connected to the Internet 150, and to transmit responses from the web servers to the requesting clients.

The environment 100 also includes a secure authentication website 160 connected to the Internet 150. In some implementations, the secure authentication website 160 is accessed by the one or more devices 130a-c via the proxy server 140. The one or more devices 130a-c may access the secure authentication website using a secure communications method, such as, for example, HTTPS. The secure authentication website 160 may prompt the user of the one or more devices for user-specific credentials. In some locations, the user-specific credentials may include a username and password, a certificate, an encryption key, the token, or any other suitable credentials or combination of credentials. Because the user-specific credentials are transmitted using the secure communications method, an attacker cannot easily obtain the user-specific credentials by simply sniffing on the internal network 110. An attacker may be able to learn the device-specific credentials by sniffing on internal network 110, but knowing these credentials may only allow the attacker to access the secure authentication website 160. In some implementations, the attacker may not be able to gain access to other parts of the internal network 110 because the proxy server 140 may restrict access of a device that has only authenticated with a device-specific username. Such a device may only be permitted to access the secure authentication website 160, and thus may not be able gain access to other components on the internal network 110, such as the authentication system 170.

When the user-specific credentials are received by the secure authentication website 160, the secure authentication website 160 communicates with the authentication system 170 to verify the user-specific credentials. This communication may occur through one or more security mechanisms, such as, for example, firewall 190. If the user-specific credentials are verified, the device associated with the user may be placed into a less restrictive profile allowing it to access additional websites in addition to the secure authentication website, such as, for example, the one or more websites 180.

In some implementations, after the user-specific credentials are received and verified, the proxy server 140 may associate each request received from the one or more devices 130a-c with the specific user currently using the device in question. This association may occur by examining the device-specific credentials received with the request and determining the currently associated user-specific credentials. In some implementations, the proxy server 140 may apply a user-specific profile to requests from the one or more devices 130a-c based on the associated user-specific credentials. In some instances, the proxy server 140 may use the correlation between user and device to log users off of shared devices after a maximum usage time is reached.

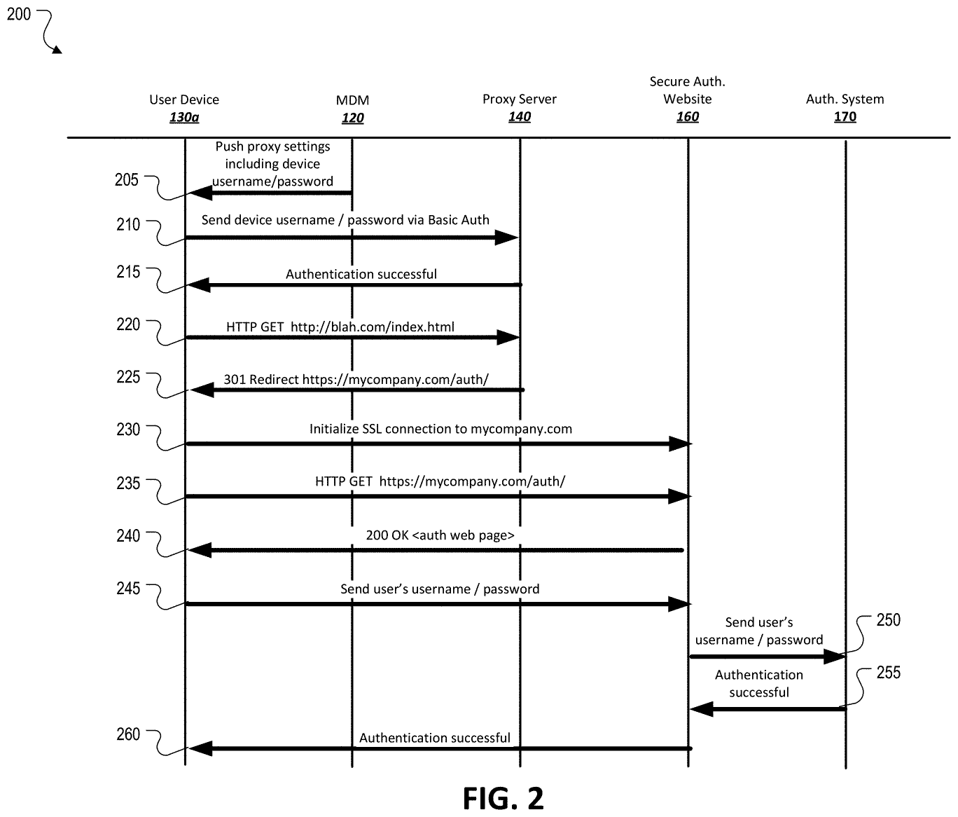

FIG. 2 is a swim lane diagram of an example of an interaction 200 between various components of the example environment to perform two-stage device and user authentication. In some implementations, the interaction 200 may include additional and/or different components not shown in the swim lane diagram. Components may also be omitted from the interaction 200, and additional messages may be added to the interaction 200.

At 205, the MDM 120 pushes proxy settings to the user device 130a. In some implementations, the proxy settings include information allowing the user device 130a to communicate with the proxy server such as, for example, an IP address and port of the proxy server, a list of authentication mechanisms supported by the proxy server, and/or any other suitable settings information. The proxy settings may also include device-specific credentials associated with the user device 130a such as, for example, a device-specific username and password. In some implementations, the proxy settings are pushed to the user device 130a by the MDM 120 when an administrator updates a profile associated with the user device 130a, or assigns a new profile to the user device 130a. The proxy settings may also be pushed to the user device 130a by the MDM 120 according to a schedule, and/or when the user device 130a first appears on the network.

At 210, the user device 130a sends the device-specific username and password to the proxy server 140 via the Basic Auth authentication method. This authentication method is described above relative to FIG. 1, and includes sending a username and password in unencrypted plaintext to the proxy server 140. At 215, the proxy server sends an indication to the user device that the authentication was successful. In some cases, if the user device-specific username and password are not valid, the proxy server 140 may return an “authentication failed” indication to the user device 130a. In such a case, user device 130a may abort authentication or may retry.

At 220, user device 130a sends a request via HTTP for the website associated with the URL http://blah.com/index.html. In some implementations, this request may include the device-specific username and password sent at 210. The proxy server 140 may examine this HTTP request and determine that it is originating from an unauthenticated user. For example, the proxy server 140 may analyze the device-specific username and password and determine that the user device 130a is authenticated only with the device-specific username and password but not with a user-specific username and password. Proxy server 140 may also determine that the user device 130a is assigned a limited access profile such that it can access only the secure authentication website 160.

In response to determining that the user device 130a is authenticated only with a device-specific username and password, the proxy server 140, at 225, sends a redirect message to the user device 130a directing it to the secure authentication website 160. In some implementations, the redirection may be an HTTP redirect message including a URL associated with secure authentication website 160, as shown in FIG. 2. The redirection may also involve the proxy server 140 communicating with the secure authentication website 160 on behalf of the user device and forwarding the response page to the user device 130a.

At 230, the user device 130a initializes an SSL connection to the secure authentication website 160. In some implementations, 230 may involve handshaking or other interaction between the user device 130a and the secure authentication website 160. Although the secure connection is illustrated as an SSL connection in FIG. 2, other types of secure connections may be used, including, but not limited to, Transport Layer Security (TLS), Multiplexed Transport Layer Security (MTLS), connections where data is encrypted prior to transport with an encryption algorithm such as Advanced Encryption Standard (AES), and/or any other suitable technique.

At 235, the user device 130a sends an HTTP request to the secure authentication website 160. In some implementations, the HTTP request includes the redirection URL sent by the proxy server 140 at 225. At 240, the secure authentication website 160 responds with an authentication webpage. In some implementations, the authentication webpage includes features allowing the user of the user device 130a to enter a user-specific username and password into the authentication webpage. At 245, the user-specific username and password are then sent to the secure authentication website, such as, for example, when the user submits the authentication webpage. At 250, secure authentication website 160 sends the user-specific username and password to the authentication system 170 for verification. As discussed previously, this interaction may occur via a network protocol such as LDAP, via an API, or by any other suitable mechanism. At 255, the authentication system responds with indication that authentication was successful. In some implementations, if the user-specific username and password are not verified, the authentication system 170 may return an indication that authentication was not successful.

At 260, secure authentication website 160 sends an indication that authentication was successful to the user device 130a. In some implementations, this indication may be a webpage indicating successful authentication. Such a webpage may inform the user that they have successfully authenticated and are now free to browse the wider Internet.

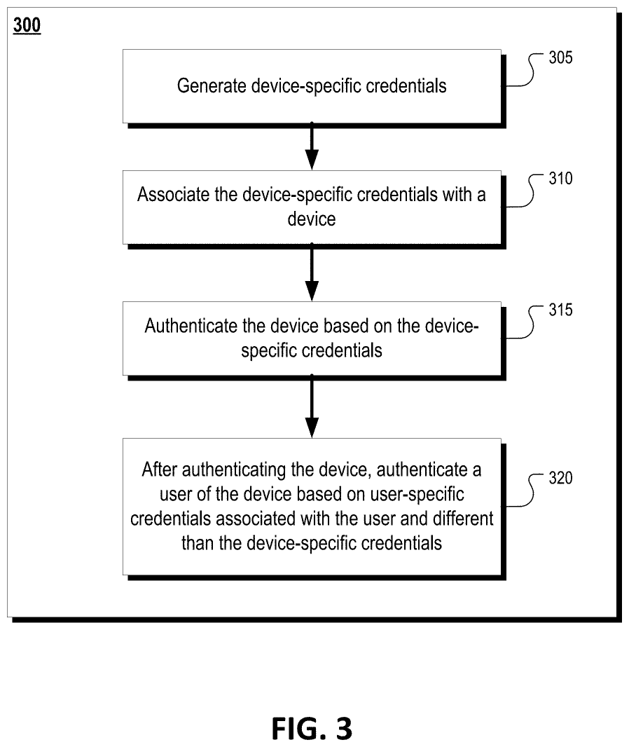

FIG. 3 is a flow chart of an example of a method 300 for generating and authenticating device-specific credentials.

At 305, device-specific credentials are generated. In some implementations, the device-specific credentials may be generated by a mobile device management system or MDM (e.g., 120), such as that described relative to FIG. 1. In some implementations, the device-specific credentials are randomly generated. The device-specific credentials may also be generated according to parameters provided by an administrator. For example, the administrator may specify that generated usernames and passwords must include a certain number of characters, must include both numbers and letters, must include special characters, or any other suitable restriction.

At 310, the device-specific credentials are associated with a device. In some implementations, the device-specific credentials are associated with the device when a profile associated with the credentials is associated with the device. For example, an administrator might set an option on a profile that enables the generation of usernames and passwords. When the user assigns this profile to a device, a username and password may be generated and associated with that device. In some implementations, the device-specific credentials may be associated with the device when the device joins the network managed by the MDM.

At 315, the device is authenticated based on the device-specific credentials. In some implementations, authenticating the device includes receiving the device-specific credentials at a proxy server (e.g., 140) and communicating with an authentication system (e.g., 170) to verify the credentials, as described relative to FIG. 1. Authenticating the device based on the device-specific credentials may also occur at a non-proxy server network element, such as a directory server.

At 320, after authenticating the device, a user of the device is authenticated based on user-specific credentials associated with the user and different than the device-specific credentials. As discussed previously, the user-specific credentials may be sent to an authentication website (e.g., 170) for verification. In some implementations, the user-specific credentials may be sent via a secure transfer mechanism.

In some implementations, authenticating the device based on the device-specific credentials occurs without user interaction. In such cases, the user may not know the device-specific credentials.

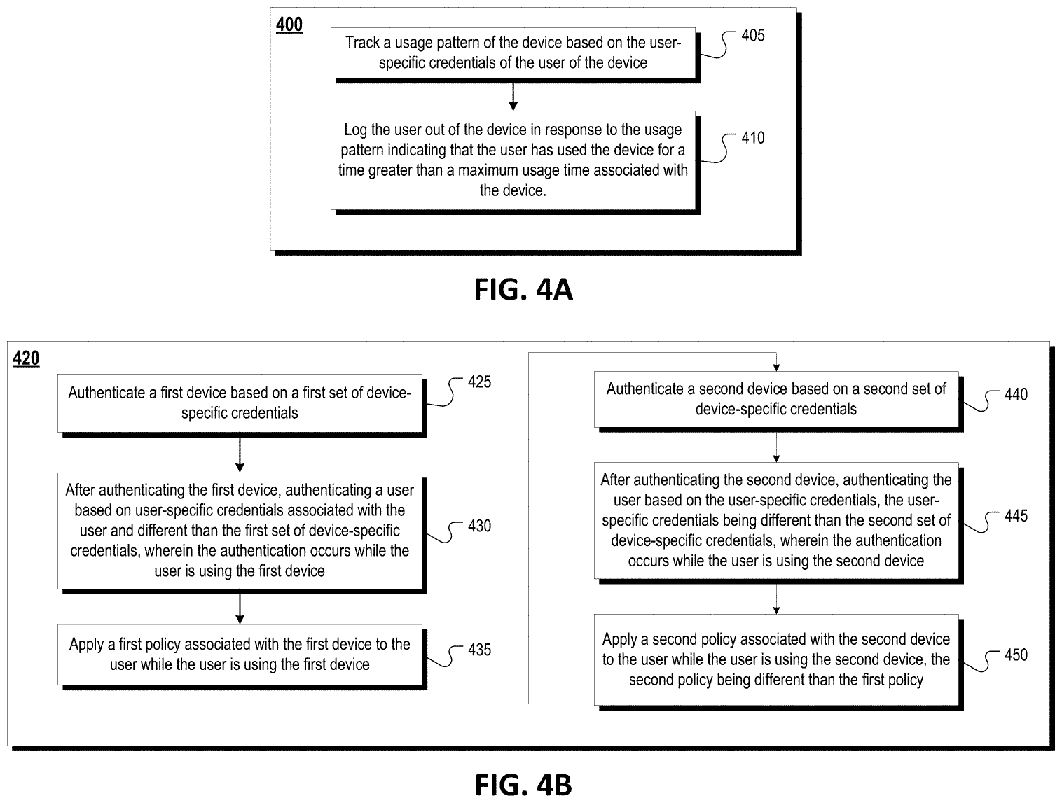

FIG. 4A is a flow chart of an example of a method 400 for tracking usage of a device and logging out a user if a predetermined condition is met, for example, a maximum usage amount is reached. At 405, the usage pattern of the device is tracked based on the user-specific credentials of a user of the device. In some implementations, the user-specific credentials and the device-specific credentials are correlated with one another to show which user is using which device at a certain time. In some implementations, this correlation occurs at an authentication system (e.g., 170). The correlation may also occur at an MDM (e.g., 120).

In some implementations, the correlation between device and user can be used to provide detailed reports of network and device usage. For example, a report may show all the users that used a certain device over a period of time. Such a report may be useful in determining which user was using the device when a prohibited activity occurred.

At 410, the user is logged out of the device in response to the usage pattern indicating that the user has met the predetermined condition, for example, used the device for a time greater than a maximum usage time associated with the device. In some implementations, this functionality may be used to enforce usage limits and/or other policies on devices that are shared among many users. For example, in a school computer lab a student can be locked out of a particular device in order to give other students a chance to use it.

FIG. 4B is a flow chart of an example process 420 of applying different policies to a user on different devices. At 425, a first device is authenticated based on a first set of device-specific credentials. At 430, after authenticating the first device, a user is authenticated based on user-specific credentials associated with the user and different than the first set of device-specific credentials, wherein the authentication occurs while the user is using the first device.

At 435, a first policy associated with the first device is applied to the user while the user is using the first device. In some implementations, the first policy may include a set of restrictions to be applied to the user's network access while using the first device. For example, the first policy may state that the user can only access a certain set of websites while using the first device. Further, the first policy may state that the user may only use the first device for a certain amount of time before logging out. In some cases, the first policy may be enforced by a proxy server (e.g., 140) through which the first device access a WAN (wide area network). The first policy may also be enforced by a network element monitoring network usage of the first device in a tap or span configuration.

At 440, a second device is authenticated based on a second set of device-specific credentials. At 445, after authenticating the second device, the user is authenticated based on the user-specific credentials, the user-specific credentials being different than the second set of device-specific credentials, wherein the authentication occurs while the user is using the second device.

At 450, a second policy associated with the second device is applied to the user while the user is using the second device, the second policy being different than the first policy. In some implementations, the second policy may allow the user to access a larger, smaller, or different set of websites or network resources than the first policy. For example, if the second device is the user's personal device and the first device is a shared device, the second policy may permit the user to access a larger set of websites than the first policy as the network owner may not be as concerned about possible damage to the user's personal device from threats such as malicious programs downloaded from the Internet.

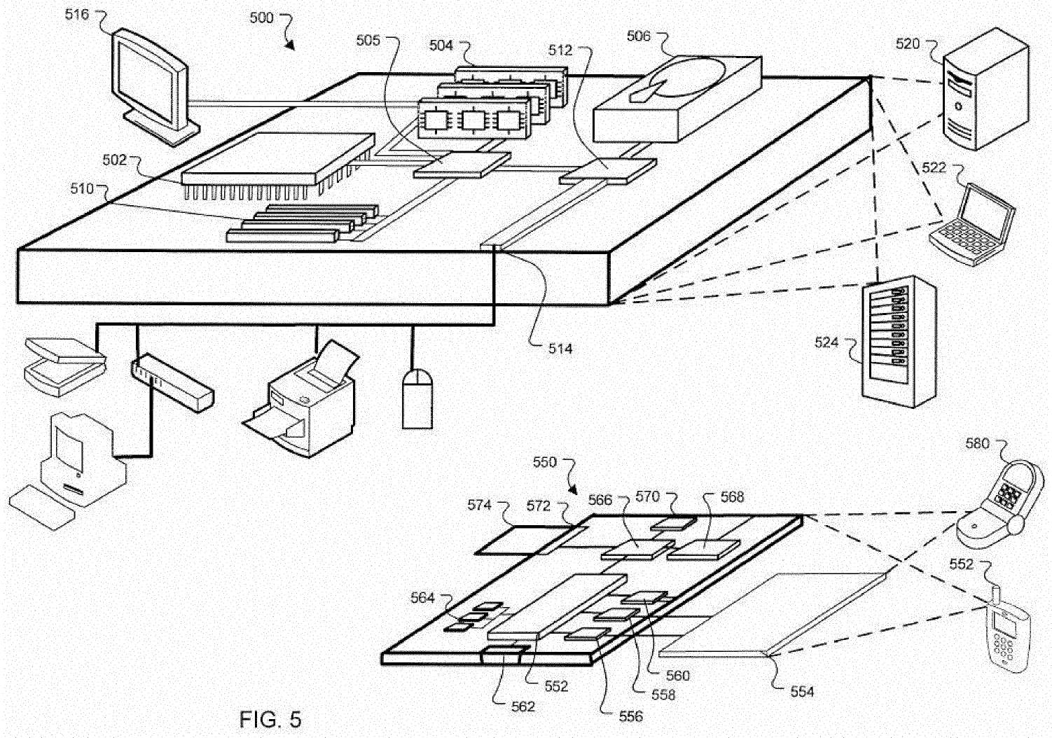

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method performed by one or more data processing apparatuses, the method comprising:
generating device-specific credentials;
associating the device-specific credentials with a device;
authenticating the device based on the device-specific credentials; and
after authenticating the device, authenticating a user of the device based on user-specific credentials associated with the user and different than the device-specific credentials.
